(19) United States
(12) Patent Application Publication
(10) Pub. No.: US 2015/0050103 A9
(43) Pub. Date: Feb. 19, 2015

(54) WASHER ARRANGEMENT FOR AN AXIAL BEARING ARRANGEMENT

(71) Applicant: GETRAG Getriebe- und Zahnradfabrik Hermann Hagenmeyer GmbH & Cie KG, Untergruppenbach (DE)

(72) Inventor: Bastian Bochert, Helfenberg (DE)

(21) Appl. No.: 14/104,191

(22) Filed: Dec. 12, 2013

(30) Foreign Application Priority Data
Dec. 14, 2012 (DE) 102012024425.8

(51) Int. Cl. F16B 43/00

(52) U.S. Cl. CPC F16B 43/002
USPC 411/531

(57) ABSTRACT

The invention relates to a washer arrangement for an axial bearing arrangement, particularly in a motor vehicle gearbox, having a first sector element and at least a second sector element, which complement one another to form an annular retaining washer. The retaining washer comprises an inner circumference and an outer circumference. The washer arrangement has a locking ring, which is arranged around the outer circumference of the retaining washer. The locking ring is wound from a wire.

### CROSS REFERENCES TO RELATED APPLICATIONS

This application claims the priority of German patent application 10 2012 024 425.8, filed Dec. 14, 2012, the content of which is incorporated herein by reference.

### BACKGROUND

The present invention relates to a washer arrangement for an axial bearing arrangement, particularly in a motor vehicle gearbox, having a first sector element and at least a second sector element, which complement one another to form an annular retaining washer, the retaining washer comprising an inner circumference and an outer circumference, and having a locking ring, which is arranged around the outer circumference of the retaining washer.

The present invention further relates to an axial bearing arrangement having a shaft, a component which is supported on the shaft, and a washer arrangement which is accommodated in a groove of the shaft, the washer arrangement being arranged adjacent to the component, in such a way that axial forces can be transmitted from the component via the washer arrangement into the shaft and/or from the shaft via the washer arrangement into the component.

In the field of vehicle gearboxes axial bearing arrangements of the aforesaid type are used to absorb axial forces, generated in transmitting power via helically toothed gear wheels, into the shaft.

Here the groove provided in the shaft is usually a circumferential ring groove. In the prior art the washer arrangement comprises two half-ring shaped washers, which are inserted radially into the groove, the axial thickness of the washer being equal to the axial width of the groove.

In order to prevent these half-ring shaped sector elements escaping from the groove under centrifugal forces as the shaft rotates in operation, a locking ring, which encloses the outer circumference of the washer arrangement, is pushed axially over the washer arrangement.

Pressing bushes, which comprise a flange that forms the washer arrangement, onto the shaft is also known.

Washer arrangements of the type described above are also referred to as thrust washers.

Here the locking ring of such washer arrangements is manufactured from a metal. Manufacturing here involves stamping the locking ring out of a metal sheet. A known alternative is to manufacture the locking ring through a metal machining process (for example turning or the like).

The manufacture of such locking rings is therefore associated with a high cost and material outlay. Production methods moreover impose geometric limits on the stamping process.

### SUMMARY

Against this background, an object of the invention is to specify an improved washer arrangement and an improved axial bearing arrangement, which in particular can be manufactured more cost effectively.

This object is achieved, in the case of the aforesaid washer arrangement, in that the locking ring is wound from a wire.

In the case of the aforesaid axial bearing arrangement the object is achieved in that the washer arrangement is a washer arrangement of the type according to the invention.

A locking ring manufactured from a wound wire is cost-effective to produce. Moreover, the material outlay can be minimized. Locking rings can furthermore be manufactured to small tolerances.

The cross section of the wire may be a circular or elliptical cross section. Alternatively it is possible for the cross section to be a polygonal cross section. The sector elements are preferably identical parts.

The object is therefore achieved in full.

It is especially preferred if the locking ring comprises a first coil, which extends through 360°, and comprises at least a second coil, which is arranged adjacent to the first coil in an axial direction and extends through at least 180°, so that over at least 180° the locking ring has an axial width which is equal to at least twice the thickness of the wire.

By doing this a locking ring can be manufactured having a very low cross section for a large width. Overall, this makes it possible, therefore, to manufacture axial bearing arrangements taking up a small radial space.

It is especially advantageous here if the second coil extends over at least 270°, in particular over at least 330°.

This makes it possible to increase the stability of the locking ring yet further.

It is generally also possible for the locking ring to comprise more than two coils, for example three coils, two of which extend over 360° and a third coil over at least 180°.

According to a further preferred embodiment the first coil comprises an off-set coil portion.

This makes it possible to limit the axial width of the locking ring to twice (or multiple times) the thickness of the wire. In other words, the locking ring may have a largely uniform axial width over the entire circumference.

In one variant the ends of the wire at not connected to other wire portions.

According to an altogether preferred embodiment, however, a first end of the wire is connected to an adjacent first wire portion of the wire, and/or a second end of the wire is connected to an adjacent second wire portion of the wire.

The stability of the locking ring can thereby be increased; in particular it is possible to limit the scope for expansion of the locking ring in a radial direction.

Here it is advantageous if the connection of the first end to the first wire portion and/or the connection of the second end to the second wire portion comprises a welded connection, a soldered connection and/or an adhesively bonded connection.

The locking ring is preferably manufactured from a metal, preferably from a spring steel. In this case a welded connection is especially preferred.

The sector elements may each be simple, half-ring shaped sector elements, as in the prior art.

It is generally also possible for the sector elements to be formed at their ends so that they are substantially captively coupled together.

In this embodiment the locking ring only needs to form an additional safeguard. In other words, elements of the forces which occur due to centrifugal forces and press the sector elements radially outwards, may be partially absorbed by the couplings of the sector elements and partially by the locking ring. The washer arrangement may also be designed so that in the operation of an axial bearing arrangement the locking ring has to absorb basically no radial forces and consequently serves as a “retaining ring”.

In one variant the first sector element here comprises a first connecting face having a first projection, the second sector element comprising a first mating connecting face having a first recess, in which the first projection engages, in such a way that the first sector element and the second sector element are captively coupled together.

In an alternative embodiment a first end of each sector element comprises a latching lug, a second end of each sector element comprising a latching groove, and the sector elements, in order to form a retaining washer, being connectible to one another so that the latching lug of the first sector element latches in the latching groove of the second sector element, the latching connection being designed so that the sector elements are captively coupled together.

The captive coupling relates in particular to a captive locking in a radial direction.

In the axial bearing arrangement according to the invention the axial width of the groove may be equal to the axial width of the sector elements or the washer arrangement. In this case the sector elements are inserted radially into the groove, it then being possible to push the locking ring on axially over the retaining washer produced in this way.

In a preferred development an axial width of the groove is greater than an axial thickness of the washer arrangement, the axial bearing arrangement furthermore comprising an annular part, which is inserted into the groove axially adjacent to the washer arrangement, in such a way that axial forces can be transmitted from the component via the washer arrangement and the annular part into the shaft and/or from the shaft via the annular part and the washer arrangement into the component.

In this embodiment it is firstly possible for the sector elements to be pushed axially into one another to form a captive coupling, the axial groove width in this case being equal to at least twice the width of the washer arrangement.

This represents a way, in particular, of achieving washer arrangements with captive couplings. After putting the sector elements together axially, the annular part can then be inserted into the groove in order to “fill” this and consequently to allow a transmission of axial forces from the component into the shaft.

It is particularly advantageous here if the annular part is an open annular part, which is inserted radially into the groove.

The development of having an axial groove width greater than the axial thickness of the washer arrangement furthermore has the advantage that the washer arrangement can be arranged at least partially in an axial direction inside an axial recess in the component. It is thereby possible to reduce the axial distance between the component and a further component supported on the shaft adjacent to the former.

Such an arrangement of the washer arrangement inside an axial recess of the component furthermore results in an additional captive locking in a radial direction.

Even in this embodiment it is nevertheless advantageous if the locking ring is provided, since the locking ring in this embodiment is able to rotate together with the retaining washer in the direction of rotation and only slight friction forces consequently occur. The component and the retaining washer may have different speeds of rotation, however, so that a radial locking solely by means of an inner circumference of an axial recess in the component could lead to higher friction losses.

The offset coil portion of the first coil is preferably an axially offset coil portion and is preferably formed as a double-offset coil portion, in such a way that the second coil, which adjoins the offset coil portion, can be arranged directly adjacent to the first coil.

It goes without saying that the features specified above and those still to be explained below can be used not only in the particular combination stated but also in other combinations or in isolation, without departing from the scope of the present invention.

### BRIEF DESCRIPTION OF THE DRAWINGS

Exemplary embodiments of the invention are represented in the drawings and are explained in more detail in the following description. In the drawings:

FIG. 1 shows a schematic view in longitudinal section through a gearbox arrangement having an axial bearing arrangement according to the invention;

FIG. 2 shows an axial top view of a retaining washer for an axial bearing arrangement;

FIG. 3 shows a further schematic view in longitudinal section through a gearbox arrangement having a further embodiment of an axial bearing arrangement according to the invention;

FIG. 4 shows an axial top view of a retaining washer for an axial bearing arrangement;

FIG. 5 shows an axial top view of an embodiment of a locking ring for a washer arrangement according to the invention and an axial bearing arrangement according to the invention;

FIG. 6 shows a sectional view along the line VI-VI in FIG. 5;

FIG. 7 shows a radial top view of the locking ring in FIGS. 5 and 6;

FIG. 8 shows a radial top view of an alternative embodiment of a locking ring according to the invention; and

FIG. 9 shows a further schematic view in longitudinal section through a gearbox arrangement having a further embodiment of an axial bearing arrangement according to the invention.

### DESCRIPTION OF PREFERRED EMBODIMENTS

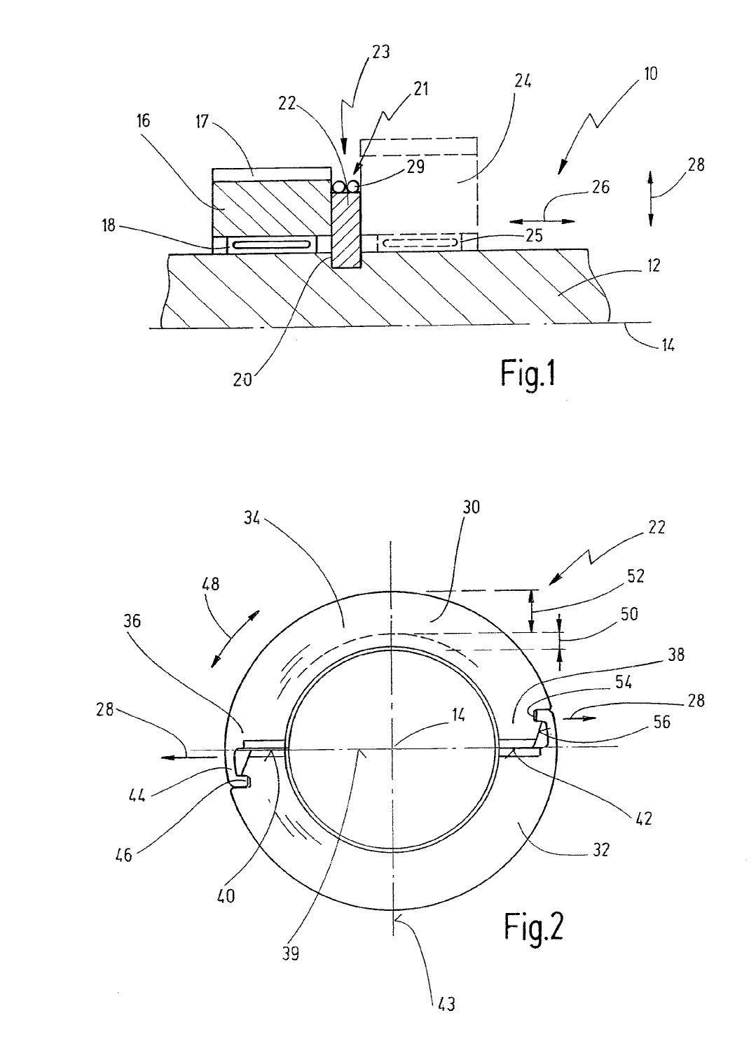

In FIG. 1 a gearbox arrangement, in particular in the form of a part of a motor vehicle gearbox, is represented in a schematic view in longitudinal section and is denoted generally by 10.

The gearbox arrangement 10 comprises a shaft 12 having a longitudinal axis 14. A first idler gear 16, which has a helical toothing 17, is rotatably supported on the shaft 12 by means of a first idler gear bearing 18.

On an axial side adjacent to the first idler gear 16 a circumferential radial groove 20 extending through 360° is formed in the shaft 12. A retaining washer 22 in the form of a thrust washer is inserted into the radial groove 20, the retaining washer 22 being part of a washer arrangement 21. An axial bearing arrangement 23 is thereby formed, by means of which axial forces, which occur due to a meshing tooth engagement, can be introduced into the shaft 12 from the idler gear 16 via the retaining washer 22. Here the retaining washer 22 is embodied as an annular disc and comprises a radially inner engagement portion, which is accommodated in the radial groove, and an abutting portion, which on one axial side is designed to bear against an axial end side of the idler gear 12, in order to be able to transmit the axial forces from the idler gear 16 into the shaft 12.

FIG. 1 furthermore represents a second idler gear 24 possibly supported on the shaft 12. The second idler gear 24 is supported on the shaft 12 by means of a second idler gear bearing 25 and has an axial end side which bears on the retaining washer 22 (on the opposite side to the idler gear 16). Any axial forces from the second idler gear 24 can thereby also be introduced into the shaft 12 via the retaining washer 22.

FIG. 1 further shows an axial direction at 26 parallel to the longitudinal axis 14 and a radial direction perpendicular thereto at 28.

Here the retaining washer 22 is formed by at least two sector elements, which can be connected to form a circular shape. It is thereby possible to push the sector elements into the radial groove 20 from radially opposite sides.

The washer arrangement 21 further comprises a locking ring 29. The locking ring 29 is arranged around the outer circumference of the retaining washer 22 and prevents the two sector elements escaping from the annular groove in a radial direction, especially when the shaft 12 is set in rotation and centrifugal forces consequently act on the sector elements.

In further variants, as described below, the sector elements may also be provided with coupling elements, so that the two sector elements are captively coupled together even without a locking ring 29. In this case the locking ring 29 may serve as an additional retaining ring. Alternatively the centrifugal forces occurring may be absorbed both by the coupling means and by the locking ring 29.

The locking ring 29 here is wound from a wire and comprises two coils, which are arranged side by side in an axial direction. The locking ring can thereby have a relatively large axial width in relation to the radial thickness.

FIG. 2 shows an example of a retaining washer 22, which comprises coupling means for captively fixing the sector elements to one another.

The retaining washer 22 in FIG. 2 comprises a first sector element 30 and a second sector element 32. The sector elements 30, 32 are of identical design. Only the sector element 30 is explained below, these explanations relating equally to the second sector element 32.

The sector element 30 comprises a half-ring shaped basic structure 34 having a first end 36 and a second end 38. Here the basic structure is embodied as a flat annular disc structure, which may be stamped out from a sheet metal material, for example.

The sector element 30 extends substantially over a circumferential area of 180°, so that the two sector elements 30, 32 together can form the annular retaining washer 22.

The retaining washer 22 has a first main axis 39, which runs through a centre of the retaining washer 22. The end faces of the two ends 36, 38 are oriented along this first main axis 39. Here a first connecting face 40 is formed at the first end 36. A second connecting face 42 is formed at the second end 38. The connecting faces 40, 42 are oriented in a radial direction parallel to the first main axis 39.

The retaining washer 22 furthermore has a second main axis 43, which runs through the centre of the retaining washer 22 and is oriented perpendicular to the first main axis 39.

The sector element 30 comprises a latching lug tongue 44, which extends from the first connecting face 40 in a circumferential direction. Here the latching lug tongue 44 is formed in the area of the outer circumference of the basic structure 34. A radial outside of the latching lug tongue 44 merges smoothly into the outer circumference of the basic structure 34. A latching lug 46, which extends radially inwards, is formed at the free end of the latching lug tongue 44.

A circumferential direction is shown at 48 in FIG. 2.

The retaining washer 22 comprises a radially inner, annular engagement portion 50, which is designed to be inserted into a radial groove 20 of a shaft 12. The retaining washer 22 further comprises a radially outer abutting portion 52, which for axial contact is formed on a component such as an idler gear 16.

Viewed in a radial direction, the latching lug tongue 44 is formed in the area of the abutting portion 52, at any rate radially outside the engagement portion.

The second end 38 of the basic structure 34 of the sector element 30 comprises a latching groove 54. The latching groove 54 extends radially inwards from an outer circumference of the basic structure 34. The latching groove 54 is offset in a circumferential direction relative to the second connecting face 42. An insertion bevel 56 is formed between the locating groove 54 and the second connecting face 42.

The sector elements 30, 32, as stated, are produced as identical parts. To produce the retaining washer 22 the sector elements 30, 32 are pushed towards one another in a radial direction into the radial groove 20, enclosing the shaft 12, that is to say along the second main axis 43. In so doing the latching lugs 46, in the area of the second connecting faces 42, reach the insertion bevels 56, so that under further radial compression the latching lug tongues 44 are deflected in a radial direction, as is indicated at 28 in FIG. 2. Finally the latching lugs 46 reach the area of the latching grooves 54, into which the latching lugs snap owing to the resilient characteristic of the latching lug tongues 44. In this position the first connecting faces 40 bear against the second connecting faces 42. This ensures that the sector elements 30, 32 latch stably against one another in a circumferential direction. The fact that the engagement portion 50, in this state, is located in the radial groove 20 means that the sector elements are captively locked.

The latching engagement of the latching lugs 46, which grip behind the latching grooves 54, affords captive locking, especially also in a radial direction.

In an alternative embodiment, which is not shown in FIG. 2, the latching lug tongues may also be capable of deflection in an axial direction, instead of a radial direction, radial grooves in this case extending in an axial direction at the second ends.

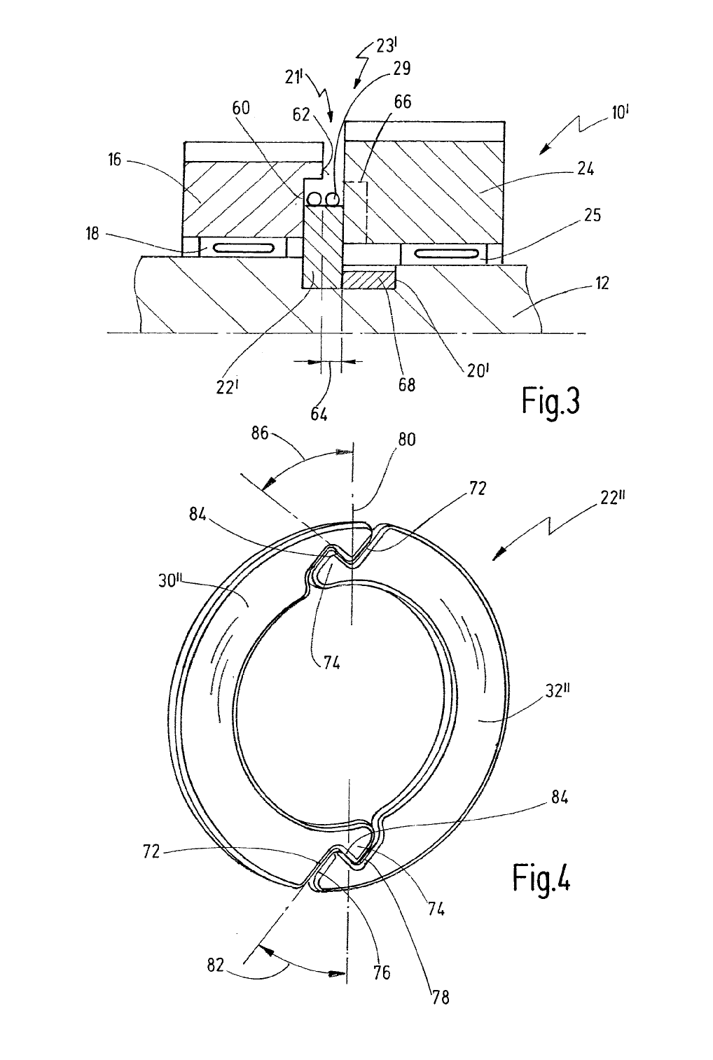

FIG. 3 represents a further embodiment of a gearbox arrangement, which in terms of construction and working principle corresponds generally to the gearbox arrangement 10 in FIG. 1 and is generally denoted by 10′. Identical elements are therefore described by the same reference numerals. It is mainly the differences which are explained below.

In the gearbox arrangement 10′ in FIG. 3 the first idler gear 16 comprises an axial recess 60, which is set back in relation to an end face 62 of the idler gear 16. In this embodiment the retaining washer 22′ is inserted into the radial groove 20′ so that in an axial direction the retaining washer 22′ is at least partially accommodated in the axial recess 60. It is thereby possible to reduce the axial distance 64 between the first idler gear 16 and the second idler gear 24. A corresponding optional axial recess 66 may, if necessary, be formed in the second idler gear 24.

Furthermore, in the embodiment in FIG. 3 the radial groove 20 is wider in an axial direction than the retaining washer 22′. To be more precise, the axial width of the radial groove 20′ is preferably twice the axial thickness of the retaining washer 22″.

In the axial bearing arrangement 23′ shown in FIG. 3 the retaining washer 22″ may again be produced from at least two sector elements, which are brought together in the radial groove 20′ axially adjacent to the first idler gear 16 and then pushed in an axial direction into the axial recess 60. An annular part 68 is then accommodated in the radial groove 20′. Consequently axial forces from the first idler gear 16 can be introduced into the shaft 12 via the retaining washer 22′ and the annular part 68. Although a certain captive locking may already be afforded by the inner circumference of the axial recess 60, due to the fact that the retaining washer 22″ is at least partially accommodated in the axial recess 60, a locking ring 29, which again may be wound from wire, as in the embodiment in FIG. 1, is preferably also inserted between the outer circumference of the retaining washer 22″ and the inner circumference of the axial recess 60.

FIG. 4 shows an alternative embodiment of a retaining washer 22″, which in the axial bearing arrangement 23′ in FIG. 3 can be used as an alternative to the retaining washer 22 in FIG. 2.

The retaining washer 22″ likewise comprises a first sector element 30″ and a second sector element 32″. The sector elements 30″, 32″ are provided at their ends with projections and recesses, so that in order to form the retaining washer 22″ the sector elements have to be pushed axially into one another, at the same time thereby achieving a radial captive locking.

To be more precise, the first sector element 30″ at one end has a first connecting face 72, on which a first projection 74 is formed. At an associated end the second sector element 32″ correspondingly has a first connecting face 76, on which a recess 78 is formed.

A central or main axis 80 corresponding to the main axis 39 runs through these coupling portions. Here the connecting face 72 and the connecting face 76 are oriented at an angle 82 to the central axis 80 which is greater than 0° and preferably less than 90°.

The projection 74 has a transverse face 84, which is oriented transversely to the connecting face 72 and which is oriented at an angle 86 to the central axis 80, the angle 86 likewise preferably being greater than 0° and preferably less than 90°.

FIGS. 5 to 7 show an embodiment of a locking ring 29, which is suitable for all of the aforementioned washer arrangements 21 and axial bearing arrangements 23.

The locking ring 29 is wound from a wire, which may be a metal wire, in particular a spring wire. In FIGS. 5 to 7 the cross section of the wire is polygonal (for example square), but may also be circular or also elliptical as indicated in FIGS. 1 and 3.

To produce the locking ring 29 the wire is wound so that a first coil 90 extends through 360° and a second coil 92 extends through at least 180°, in this case through an angle range 94 of 330°, for instance.

Here the first coil 90 comprises a double-offset coil portion 86, with the second coil 92 adjoining the end thereof.

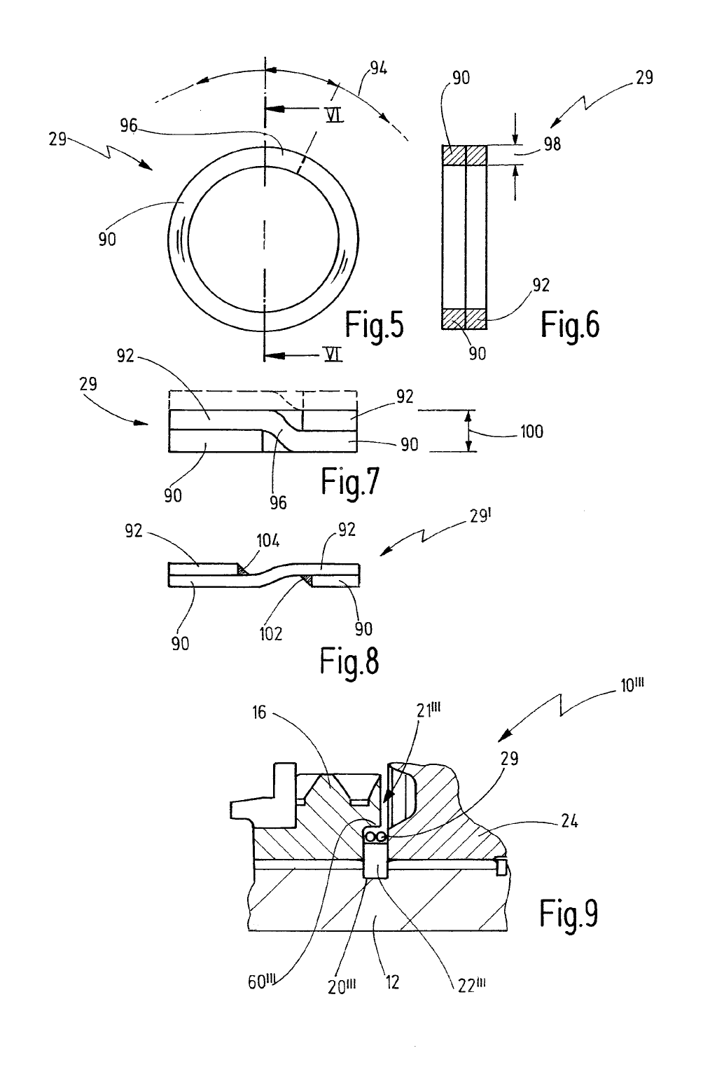

The two coils 90, 92 are consequently arranged adjacent to one another in an axial direction, so that the locking ring 29 produced in this way has an axial width 100 which is twice the wire thickness 98, as is indicated in FIG. 6.

The locking ring 29 can be produced by bending the wire around a mandrel.

In this case the ends of the wire may lie open.

FIG. 7 shows an alternative embodiment in which the ends of the wire are connected at respective connections 102, 104 to axially adjacent wire portions, for example by a welded connection, by an adhesively bonded connection or the like.

FIG. 9 shows a further embodiment of a gearbox arrangement 10′″, which in terms of construction and working principle corresponds to the gearbox arrangements described above.

Here the axial width of the radial groove 20′″ is equal to the axial thickness of the retaining washer 22″. A locking ring 29 of the type described above is arranged around the outer circumference of the retaining washer 22″. The washer arrangement 21″ thus formed is arranged virtually in its entirety in an axial recess 60′″ of the first idler gear 16, so that the axial distance between the first idler gear 16 and the second idler gear 24 may be small.

The radial outside diameter of the locking ring 29 is preferably smaller than the inner circumference of the axial recess 60″.

Although retaining washers 22 comprising two sector elements are represented above, the retaining washers may also naturally be made from three or more sector elements, which complement one another to form a circular shape.

1. Washer arrangement for an axial bearing arrangement, having a first sector element and at least a second sector element, which complement one another to form an annular retaining washer, the retaining washer comprising an inner circumference and an outer circumference, and having a locking ring, which is arranged around the outer circumference of the retaining washer, wherein the locking ring is wound from a wire.

2. Washer arrangement according to claim 1, wherein the locking ring comprises a first coil, which extends through 360° and comprises at least a second coil, which is arranged adjacent to the first coil in an axial direction and extends through at least 180°, so that over at least 180° the locking ring has an axial width which is equal to at least twice the thickness of the wire.

3. Washer arrangement according to claim 2, wherein the second coil extends over at least 270°.

4. Washer arrangement according to claim 2, wherein the first coil comprises an offset coil portion.

5. Washer arrangement according to claim 1, wherein a first end of the wire is connected to an adjacent first wire portion of the wire.

6. Washer arrangement according to claim 5, wherein a second end of the wire is connected to an adjacent second wire portion of the wire.

7. Washer arrangement according to claim 5, wherein the connection of the first end to the first wire portion comprises at least one of a welded connection, a soldered connection and an adhesively bonded connection.

8. Washer arrangement according to claim 1, wherein the first sector element comprises a first connecting face having a first projection, the second sector element comprising a first mating connecting face having a first recess, in which the first projection engages, in such a way that the first sector element and the second sector element are captively coupled together.

9. Washer arrangement according to claim 1, wherein a first end of each sector element comprises a latching lug, a second end of each sector element comprising a latching groove, and the sector elements, in order to form a retaining washer, being connectible to one another so that the latching lug of the first sector element latches in the latching groove of the second sector element, the latching connection being designed so that the sector elements are captively coupled together.

10. Axial bearing arrangement having a shaft, a component which is supported on the shaft, and a washer arrangement which is accommodated in a groove of the shaft, the washer arrangement being arranged adjacent to the component, in such a way that axial forces can be transmitted at least one of from the component via the washer arrangement into the shaft and from the shaft via the washer arrangement into the component, wherein the washer arrangement has a first sector element and at least a second sector element, which complement one another to form an annular retaining washer, the retaining washer comprising an inner circumference and an outer circumference, and having a locking ring, which is arranged around the outer circumference of the retaining washer, and wherein the locking ring is wound from a wire.

11. Axial bearing arrangement according to claim 10, wherein the locking ring comprises a first coil, which extends through 360° and comprises at least a second coil, which is arranged adjacent to the first coil in an axial direction and extends through at least 180°, so that over at least 180° the locking ring has an axial width which is equal to at least twice the thickness of the wire.

12. Axial bearing arrangement according to claim 11, wherein the second coil extends over at least 270°.

13. Axial bearing arrangement according to claim 11, wherein the first coil comprises an offset coil portion.

14. Axial bearing arrangement according to claim 10, wherein a first end of the wire is connected to an adjacent first wire portion of the wire.

15. Axial bearing arrangement according to claim 14, wherein a second end of the wire is connected to an adjacent second wire portion of the wire.

16. Axial bearing arrangement according to claim 14, wherein the connection of the first end to the first wire portion comprises at least one of a welded connection, a soldered connection and an adhesively bonded connection.

17. Axial bearing arrangement according to claim 10, wherein the first sector element comprises a first connecting face having a first projection, the second sector element comprising a first mating connecting face having a first recess, in which the first projection engages, in such a way that the first sector element and the second sector element are captively coupled together.

18. Axial bearing arrangement according to claim 10, wherein a first end of each sector element comprises a latching lug, a second end of each sector element comprising a latching groove, and the sector elements, in order to form a retaining washer, being connectible to one another so that the latching lug of the first sector element latches in the latching groove of the second sector element, the latching connection being designed so that the sector elements are captively coupled together.

19. Axial bearing arrangement according to claim 10, wherein an axial width of the groove is greater than an axial thickness of the washer arrangement, the axial bearing arrangement furthermore comprising an annular part, which is inserted into the groove axially adjacent to the washer arrangement, in such a way that axial forces can be transmitted at least one of from the component via the washer arrangement and the annular part into the shaft and from the shaft via the annular part and the washer arrangement into the component.

20. Axial bearing arrangement according to claim 19, wherein the annular part is an open annular part, which is inserted radially into the groove.
